(19) United States
(12) Patent Application Publication
(10) Pub. No.: US 2004/0230478 A1
(43) Pub. Date: Nov. 18, 2004

(54) Method and system for streamlining recruitment process through independent certification of resumes

(76) Inventor: Himanshu Saxena, Columbus, OH (US)

Correspondence Address: Mr. Himanshu Saxena, 2807 Chateau Circle, Columbus, OH, 43221, US

(21) Appl. No.: 10/838,451

(22) Filed: May 4, 2004

Related U.S. Application Data
(60) Provisional application No. 60/471,374, filed on May 15, 2003.

(51) Int. Cl. G06F 17/60

(52) U.S. Cl. 705/11

(57) ABSTRACT

The present invention is a method and system for improving the current recruiting process. The traditional system of recruitment is essentially faith-based, wherein the hiring entities place faith in the alleged credentials of an applicant. Only at the final stages of recruitment, some hiring entities attempt to verify the alleged credentials of applicants. If, at this stage, the applicants are caught lying about their credentials, the hiring entities are forced to restart the whole recruiting process. The present invention is a method and system that would transfer the responsibility of verifying alleged credentials from hiring entities to applicants. Additionally, the present invention provides a method and system for applicants to get their resume certified prior to applying for any position with any hiring entity. The present invention streamlines the recruitment process by shifting the verification stage from the end of the recruiting process to the beginning of the recruiting process.

This non-provisional application for patent is a continuation (claiming the benefit under 35 USC 119(e)) of the provisional application No. 60/471,374 which was filed on May 15, 2003.

### BACKGROUND OF THE INVENTION

The present invention is directed to streamlining the recruitment process, and more particularly to a method and system for enabling applicants to get their credentials certified at the onset of a recruiting process.

One of the most important responsibilities for hiring entities (such as corporations, government organizations or educational institutions) is to attract capable and honest applicants for any open position. Human resources are becoming increasingly important in this knowledge driven economy and most often a successful company differentiates itself from an unsuccessful company by the quality and skill of its employees. Hiring a new employee presents a great opportunity for the company to bring in skilled and talented people who can make significant contributions to the development and growth of the company.

In a traditional and typical recruitment process, the normal first stage of the recruitment process is to advertise one or more open positions to attract suitable candidates. As a result, many applicants express an interest in the open positions. The standard and commonly employed method for applicants to express their interest in an open position is to send a list of their credentials to the hiring entity. These credentials are normally listed on a resume, curriculum vitae or a bio-data (From here forth, a list of credentials is generically referred to as a “resume”). The hiring entities may receive many more resumes than the number of open positions. It is an arduous task for hiring entities to identify the most attractive candidates from the pool of these resumes.

Unfortunately, some of these job candidates may not be completely truthful about their credentials. In the current environment, where coveted employment opportunities or school admissions are increasingly becoming competitive, many applicants embellish their credentials on their resumes to get “a foot in the door.” The hiring entities may or may not catch the dishonest candidates at the beginning stages of the recruitment process. The situation is exacerbated by the preponderance of false or misleading information on the resumes. The following real-life statistics and examples are presented below to illustrate the growing problem of unethical applicants lying about their credentials:

45% of all resumes contain one major fabrication (Source: Society of Human Resource Management).

34% of all application forms contain outright lies about experience, education and the ability to perform essential functions of the job (Source: The Wall Street Journal).

College and University registrars report that at least 60% of the verifications they receive contain falsified information.

Employees at all levels falsify their backgrounds (Source: The Small Business Administration).

MCG Capital's CEO Bryan Mitchell claimed to have a BA from Syracuse University in at least a dozen SEC filings. The truth is that he attended the school for three years, but never graduated. (Source: http://www.forbes.com/2002/11/04/1104facesam.html)

Bausch & Lomb's CEO Ron Zarella claimed to have earned an MBA from New York University that he didn't have.

(source: http://pages.stern.nyu.edu/˜opportun/issues/2002-2003/issue05/03 bausch.htm)

Jack Talley, the CEO of a private company, EpiCept, was identified in his corporate bio-data as having an MBA in marketing from New York University. He doesn't.

(source: http://biz.yahoo.com/tsp/021023/10049646 l.html)

Veritas Ex-CFO Kenneth Lonchar was forced to quit when he admitted lying about having a Stanford MBA.

(Source:http://sanjose.bizjournals.com/sanjose/stories/2002/09/30/daily56.html)

The University of California at Berkeley's Haas School of Business rejected about 5% of the initial 100 candidates slated for admission into its fall 2003 MBA class after background checks revealed inaccuracies on their resumes. Applicants did such things as fudge work dates to conceal that they had been laid off.

(Source:http://www.businessweek.com/magazine/content/03_{—}12/c38 25015_mz003.htm)

The current system of recruitment, where an applicant sends his/her resume to a hiring entity for initial consideration, is essentially faith-based. A resume represents the first level of interaction between an applicant and a hiring entity. Based on the credentials listed on the resumes, the hiring entities make their decision to continue or discontinue their communication with the applicants. The importance placed on resumes in the recruitment process leads many applicants to embellish their credentials. Ironically, the most impressive resumes are most prone to containing embellishments. This may put honest applicants at a competitive disadvantage during the initial steps in the recruitment process.

Unfortunately, it is very hard for the hiring entities to separate honest candidates from dishonest candidates in the beginning of the recruiting process. Most often, very attractive resumes are the ones that contain false or misleading information. This “padding” of resumes is a-serious concern for hiring entities and there is a serious need for a method that can ensure the truthfulness of resumes that are sent to hiring entities for initial review.

The current process of recruitment places burden on hiring entities to separate the “honest” resumes from “padded” resumes. Considering the volume of resumes received for each open position, it is operationally, functionally, and financially prohibitive for hiring entities to verify the credentials for each resume received. This verification is normally done only for successful applicants via a “background check” at the end of the recruiting process. Many hiring entities or their agents perform a “background check” or “background screening” for successful applicants. Many companies, such as Equifax employment services and Information America, perform these background checks at the request of the hiring entities. These background checks, however, are performed at very late stages in the recruitment process. Unfortunately, if at the end stage, a hiring entity identifies errors in the alleged credentials of a successful applicant, it is forced to restart the whole hiring process. This places a tremendous burden on hiring entity resources and leads to tremendous frustration. The current system of recruitment is flawed, and may frequently result in harming both honest applicants and hiring entities.

The cost of hiring continues to increase. At the same time, the dishonesty among applicants continues to increase. Considering the statistics above, I estimate that by implementing this new process of recruitment as described in the present invention, the hiring entities can reduce their hiring costs per successful candidate by as much as 25%.

### OBJECTS AND SUMMARY OF THE INVENTION

The principal object of the present invention is to provide a method and system for streamlining the current recruitment process.

An object of the present invention is to provide a method and system for transferring the burden of certifying applicants' credentials from the hiring entities to the applicants. Yet another object of the present invention is to provide a method and system for enabling applicants to get their credentials certified.

Still yet another object of the present invention is to provide a method and system for shifting the verification stage from the end of the recruitment process to the beginning of the recruitment process.

An additional object of the present invention is to provide a method and system for enabling hiring entities to verify the validity of the certification of applicants' credentials.

In summary, the main object of the present invention is to provide a method and system for streamlining the recruitment process, transferring the burden of verifying credentials from hiring entities to applicants, enabling applicants to certify their credentials, and enabling hiring entities to verify this certification.

### BRIEF DESCRIPTION OF THE DRAWINGS

The above and other objects, novel features and advantages of the present invention will become apparent from the following detailed description of the invention illustrated in the drawings, in which:

FIG. 1 is a flow chart illustrating the current process of recruitment.

FIG. 2 is a flow chart illustrating the improved process of recruitment after the present invention is implemented.

FIG. 3 is a flow chart illustrating the process of certifying an applicant's credentials.

FIG. 4 is an illustration of a resume without certification.

FIG. 5 is an illustration of a certified resume.

FIG. 6 is an illustration of the certification information provided by the independent certification agency to a hiring entity upon request.

### DETAILED DESCRIPTION OF THE INVENTION

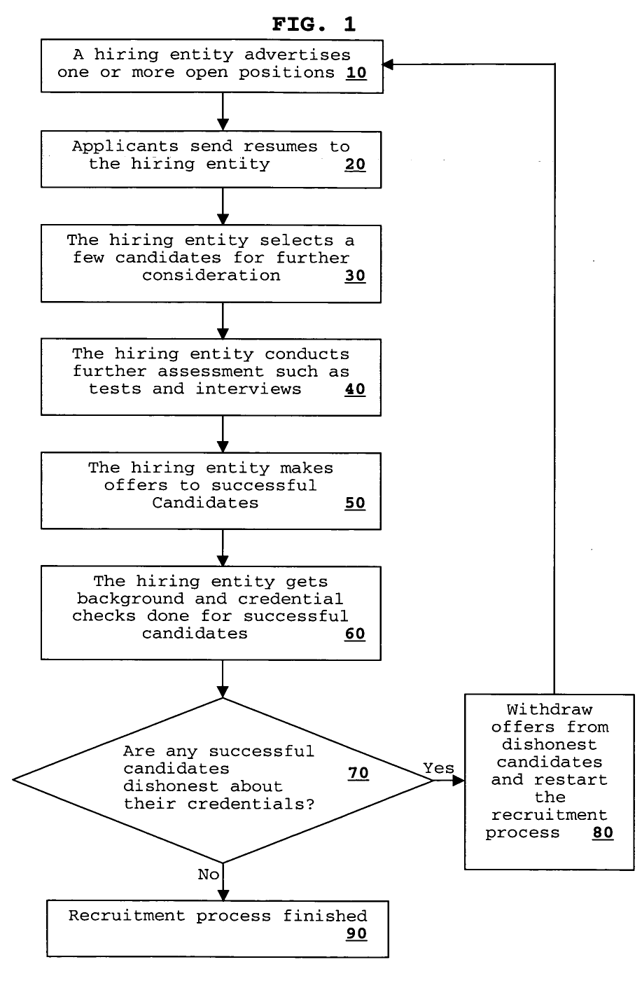

Referring to FIG. 1, in a typical recruitment process, the first step is to advertise available positions (10). There are many ways of advertising open positions, such as through newspapers, television, or the global network of computers, widely known as the “World-Wide-Web”-or “Internet”. Thi-s advertising normally leads to the hiring entity receiving resumes from many applicants interested in this position (20). Normally, many more resumes are received than the number of open positions. The next step in the recruitment process is to shortlist candidates because a hiring entity cannot interview every candidate who sends his or her resume due to operational, financial or practical reasons. Normally, the hiring entity representatives would identify the most promising candidates by comparing their credentials as listed on their resumes (30). Therefore, based on the resumes, the hiring entity makes a decision to invite a smaller group of applicants for further consideration, such as one or more personal interview (40). Based on this assessment, the hiring entity makes offers to one or more successful candidates (50). The hiring entity or its agent than conducts an optional background check to verify the veracity of successful applicants' alleged credentials (60). If any misrepresentation or discrepancies are discovered during this verification process, then based on the degree of misrepresentation, the dishonest applicants are disciplined, sometimes by withdrawing the employment offers (80). Discovering in the last stages of the recruitment process that one or more of the successful candidates had been dishonest can force a hiring entity to restart the hiring process from the very beginning (80). Therefore, the current system of recruitment, as shown in the Flow Chart in FIG. 1 may frequently result in harming both honest applicants and hiring entities.

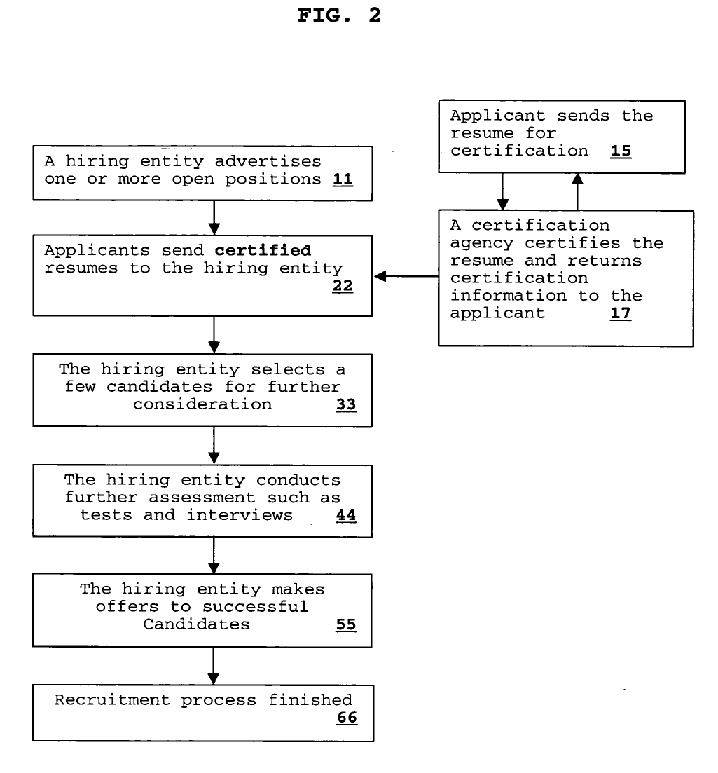

FIG. 2 illustrates a novel recruitment process that incorporates the method and system of the present invention. In this case, a prospective applicant sends his or her resume to an independent certification agency (15). This certification agency is considered independent because it is not affiliated with any particular applicant or a hiring entity. It simply serves a purpose of providing independent certification or verification service. This certification agency verifies the most significant credentials listed on applicant's resume such as the employment and educational information (17). After verifying these credentials, this certification agency classifies the resume as “certified,” issues the certification information and gives the applicant the right to add this certification information to his resume making the resume a “certified resume.” When a hiring entity advertises a position (11), the applicant sends his or her certified resume to the hiring entity (22). The hiring entity, after receiving the certified resume, can place a strong faith in the authenticity of the applicants' credentials and move through the recruitment process confidently. The hiring entity representatives would identify the most promising candidates by comparing their credentials as listed on their resumes (33). Based on the resumes, the hiring entity makes a decision to invite a smaller group of applicants for further consideration, such as one or more personal interview (44). Based on this assessment, the hiring entity makes offers to one or more successful candidates (55). This step marks the end of the recruitment process (66). The hiring entity or its agents can conduct their own optional background check for the successful candidates, if desirable.

Comparing the traditional recruitment process as illustrated in FIG. 1 to that of the novel recruitment process as suggested by present invention and as represented in FIG. 2, it is evident that the method and system of the present invention offers a novel process to streamline the recruiting process and to eliminate costly iterations in the recruiting process. The invention offers a novel process wherein the responsibility of verification of alleged credentials listed on a resume or a bio-data is shifted from the hiring entities, such as corporations to the applicants. To facilitate this shift, the invention provides for a novel method wherein the applicant gets his or her resume certified by an independent agency.

The idea of applicants getting their resumes certified by an independent entity is novel, and has not been published, mentioned or offered before.

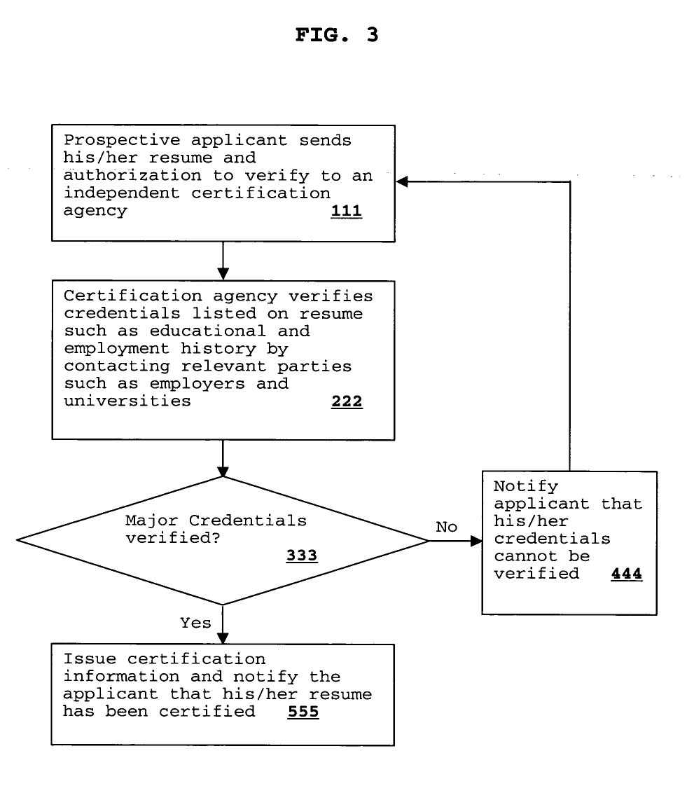

FIG. 3 illustrates the method by which the applicants can get their resume certified by an independent certification agency. Any applicant wishing to get his or her resume certified will send the resume to this independent agency (111). Additionally, they will send an authorization form to the independent agency giving this agency the right to verify this information. The independent agency will then verify the information listed on the resume, such as the employment and educational history, by contacting the relevant parties, such as education institutions and employers (222). Once this independent certification agency has satisfactorily verified the material information on the resume, the independent agency will issue certification information for the resume and will notify the applicant that his or her resume has been certified (555). The certification agency can issue a unique certification number to enable the applicant to incorporate this certification information on his or her resume. In the case where the certification agency is unable to verify the material information. listed on the resume, the agency will notify the applicant of its inability to certify his or her resume (444).

If an applicant sends his certified resume to a hiring entity, the hiring entity may choose to verify this certification. To enable this verification, the present invention provides for various methods. The hiring entity can contact the independent certification agency through any communication channel, such as telephone, fax or email. In a preferred embodiment of the invention, the hiring entity would be able to verify an applicant's certification by accessing the independent agency's website maintained on the Internet. The independent agency will maintain the list of certified credentials for all certified resumes on their computer servers. These computer servers may be connected to the Internet or the “World Wide Web.” By submitting the certification information such as the certification number and the associated password, the hiring entity will be able to access the applicant's certified credentials over the Internet.

This invention also provides for a method and system enabling the applicants to renew their certification periodically. In the case where an applicant needs to make changes such as adding educational or employment information to his or her certified resume, he or she can petition the independent certification agency to renew and update his or her certification. The independent agency will then verify these additional credentials, and upon successful verification, will update its list of certified credentials related to this applicant. The applicant can choose to either keep the old certification information or request new certification information. Any hiring entity, intending to verify this certification, will receive the updated list of certified credentials for this applicant.

### EXAMPLE 1

A Traditional Hiring Process

Referring to FIG. 1, a traditional recruiting process is described here using an illustrative example. A hiring entity namely a corporation advertises for 15 open positions (10). As a result, the corporation receives 100 resumes from eager applicants (20). The corporation, based on the credentials listed on these resumes, shortlists 30 applicants for further consideration (30) and continues the recruitment process by inviting these 30 applicants for further assessment such as further interviews (40). After this assessment, the corporation makes job offers to 15 successful candidates (50). At this stage, the corporation or its agent conducts a background check on these 15 successful candidates (60). Let us assume that 20% of these 15 successful candidates had embellished or “padded” their resumes. The embellished credentials could be the educational credentials (such as name of degrees, name of schools granting degrees, dates of enrollment, and Grade Point Averages) or the employment credentials (such as name of employers, dates of employment, and title of employment). Once the corporation discovers that 20% of these 15 successful candidates, or 3 candidates had lied about their credentials, the corporation withdraws the employment offers from these three dishonest candidates. By this stage in this recruitment process, the corporation has spend significant resources. When, at this last stage of the recruitment, the corporation finds these three dishonest applicants, the corporation is forced to restart the whole recruitment process to fill these three open positions. Since the optional verification stage is at the end of the traditional recruitment process, the possibility of this iteration becoming necessary is high.

The proposed method and system of recruitment, as shown in FIG. 2, will largely eliminate this need for iteration because it will move the verification stage to the beginning of the recruitment process. Also, by transferring the responsibility of verifying credentials from the corporation to the applicants, the burden of verification is removed from the corporation.

In this example, assuming that the cost of the recruitment process for the hiring corporation is $20,000 per successful applicant, the company would have saved $60,000 by following the recruitment method and system according to the present invention.

In this example:

Cost of recruiting by traditional recruitment (as in FIG. 1) =(15×20,000)+(3×20,000)=$360,000

Cost of recruiting by method suggested in this invention (as in FIG. 2)=(15×20,000)=$300,000

It is evident from this simple example that this corporation could reduce their recruitment cost by 20% by adopting the recruitment method and system suggested by the present invention (as shown in FIG. 2).

### EXAMPLE 2

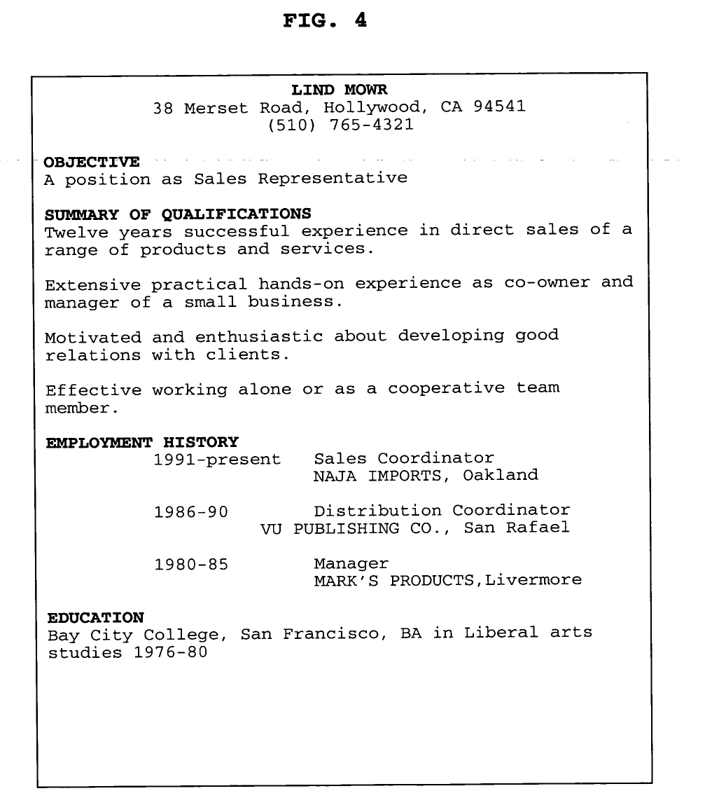

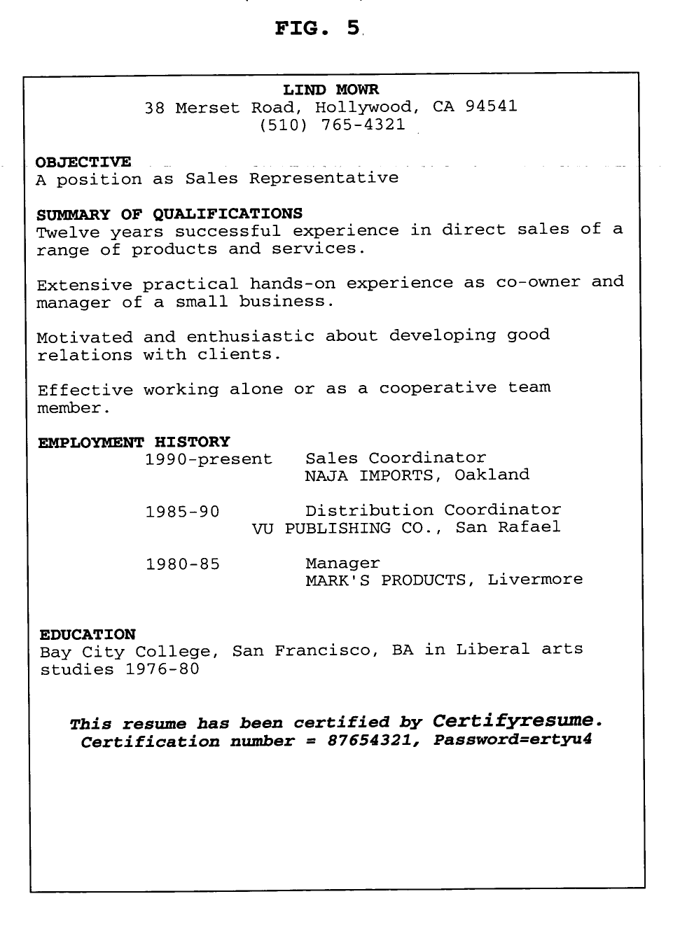

Certifying a Resume FIG. 4 illustrates an example of a resume of an applicant named Lind Mowr. His resume contains his alleged educational and employment credentials. Lind Mowr follows the process depicted in FIG. 3 and gets his resume certified by an independent certification agency called Certifyresume. Certifyresume, following the process depicted in FIG. 3, verifies the material information listed on Lind Mowr's resume. After satisfactorily verifying this information, Certifyresume notifies Lind Mowr that his resume has been certified and issues him his certification information. In this case, it issues Lind Mowr a certification number, and optionally a password associated with this certification. Lind Mowr then chooses to put this certification information on his “certified” resume. FIG. 5 illustrates Lind Mowr's certified resume containing this certification information. This password could be the applicant's last name.

### EXAMPLE 3

Accessing the Certified Information

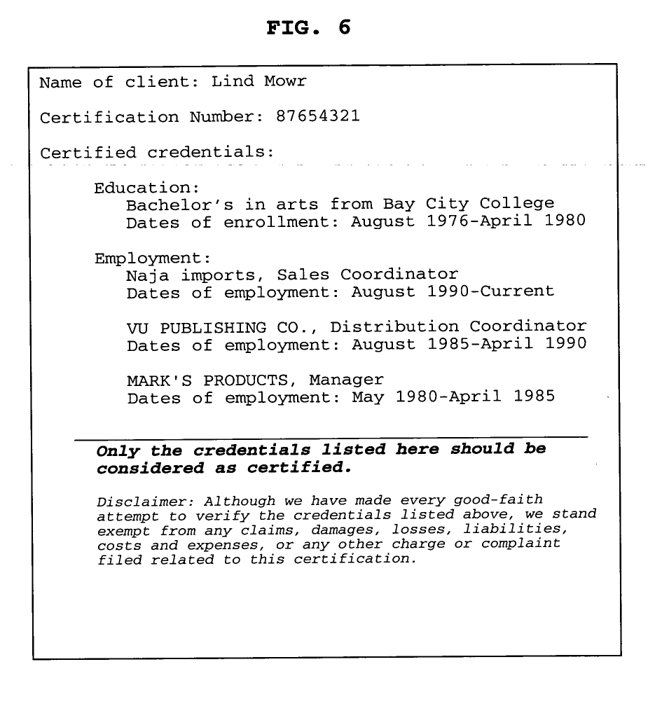

As given in Example 2, the applicant Lind Mowr gets his resume certified by an independent agency called Certifyresume. Certifyresume maintains all the certification information on their computer servers that are connected to the “world wide web” or the “Internet”. These servers are accessible through Certifyresume's “homepage” or “website” on the Internet. Lind Mowr sends his certified resume, which is shown in FIG. 5, to a hiring entity. This hiring entity, in order to verify this certification, can access Certifyresume's website on the Internet, and using the certification information listed on Lind Mowr's certified resume, namely the certification number and the password, can retrieve Lind Mowr's credentials. FIG. 6 illustrates the certified information that the hiring entity would retrieve. The hiring entity can retrieve the same information by contacting Certifyresume via phone, fax or email.

Although only a few exemplary embodiments of this invention have been described in detail above, those skilled in the art will readily appreciate that many modifications are possible in the

What is claimed is:

1) A method for certifying credentials for an individual, comprising the steps of:
Receiving the credentials from the individual;
Verifying some or all of the credentials by contacting relevant third-parties such as schools and prior employers;
Issuing the certification information for the individual.

2) A method as claimed in claim 1, wherein the list of credentials is in the form of a bio-data or a resume.

3) A method as claimed in claim 1, wherein the list of credentials can be received from the individual via postal mail, fax, email or the World Wide Web (internet).

4) A method as claimed in claim 1, wherein the individual requesting certification also provides authorization allowing the certifying agency to verify his credentials.

5) A method as claimed in claim 1, wherein the individual receives certification information, such as a certification number from the certifying agency; and subsequently can incorporate this certification information into his credentials such as to create a “certified resume.”

6) A method as claimed in claim 5, further comprising the step wherein the individual receiving the certification information sends this certification information alongside his credentials to hiring entities such as corporations, government, or educational institutions.

7) A method as claimed in claim 6, wherein the interested third parties such as the hiring entities can verify this certification information by contacting the certifying agency via postal mail, telephone, fax, email, or the World Wide Web (internet).

8) A method as claimed in claim 7, wherein the interested third parties such as the hiring entities can verify and retrieve the certification information for the individual via the website of the certifying agency.

9) A method for certifying credentials for an individual and of providing these certified credentials to interested parties, comprising the steps of:
Receiving the list of credentials from an individual;
Verifying some or all of the credentials by contacting relevant third-parties such as schools and prior employers;
Issuing the certification information for the individual;
Storing the certified credentials in a database accessible to interested third parties;
Providing the certified information to the third parties.

10) A method as claimed in claim 9, wherein the interested third parties include prospective employers, educational institutions, and government agencies.

11) A method as claimed in claim 9, wherein the interested parties can access the database of certified credentials via the certifying agency's website.

12) A method as claimed in claim 10, wherein the interested third parties can query the database of certified credentials to identify and select the individuals most desirable for their purposes.

13) A method as claimed in claim 11, wherein the interested third parties need the certification information such as the certification number from the individual to retrieve the individual's information.
